(19) United States
(12) Patent Application Publication
(10) Pub. No.: US 2016/0294660 A1
(43) Pub. Date: Oct. 6, 2016

(54) Method And Apparatus For Improved Traffic Monitoring In Wireless Communication Systems

(71) Applicants: Alcatel-Lucent USA Inc., Murray Hill, NJ (US); Alcatel-Lucent Telecom Ltd, Berkshire (GB)

(72) Inventors: Omar H. Salvador, Wheaton, IL (US); Yalou Wang, Swindon (GB)

(73) Assignees: Alcatel-Lucent USA Inc., Murray Hill, NJ (US); Alcatel-Lucent Telecom Ltd, Berkshire (GB)

(21) Appl. No.: 14/674,147

(22) Filed: Mar. 31, 2015

(51) Int. Cl. H04L 12/26; H04L 12/939; H04W 28/02

(52) U.S. Cl. CPC H04L 43/106; H04W 28/0268; H04L 49/552; H04W 28/0284; H04L 43/087

(57) ABSTRACT

Various methods and devices are provided to address the need for improved backhaul monitoring capabilities. In a first method, a network node determines whether an operational setting indicates that a traffic monitoring mode is enabled. When the traffic monitoring mode is enabled, the network node sends GTP-U packets, each GTP-U packet including a GTP-U header with an S bit set to 1 and a corresponding sequence number in a sequence number field. In a second method, a network node receives such GTP-U packets and utilizes the corresponding sequence numbers of the received GTP-U packets to provide performance measurement counts of missed GTP-U packets.

### FIELD OF THE INVENTION

The present invention relates generally to communications and, in particular, to traffic monitoring in wireless communication systems.

### BACKGROUND OF THE INVENTION

This section introduces aspects that may help facilitate a better understanding of the inventions. Accordingly, the statements of this section are to be read in this light and are not to be understood as admissions about what is prior art or what is not prior art.

Backhaul networks (e.g., those that provide connectivity for S1/X2 interfaces) are expected to reliably provide low latency, a low packet error rate (e.g., better than 0.00001), and minimal jitter (for real time services). Future small cell deployments will depend on different types of backhaul networks (such as those supported by different 3rd party providers), and VoLTE deployments will require more stringent SLA requirements. Quality of user experience degradation has been observed in the field already. At least one of these incidents were triggered by S1-U high packet loss due to a “bug” in the backhaul switch/router. Determining that the backhaul was the root cause proved difficult and time consuming, since other aspects of the system were investigated first.

Thus, new solutions and techniques that can provide better backhaul monitoring capabilities would meet a need and advance wireless communications generally.

### BRIEF DESCRIPTION OF THE DRAWINGS

FIG. 1 is a logic flow diagram of functionality performed by a sending network node in accordance with various embodiments of the present invention.

FIG. 2 is a logic flow diagram of functionality performed by a receiving network node in accordance with various embodiments of the present invention.

FIG. 3 is a block diagram depiction of a 3GPP LTE wireless network in accordance with certain embodiments of the present invention.

FIG. 4 is a block diagram depiction of two network nodes in accordance with various embodiments of the present invention.

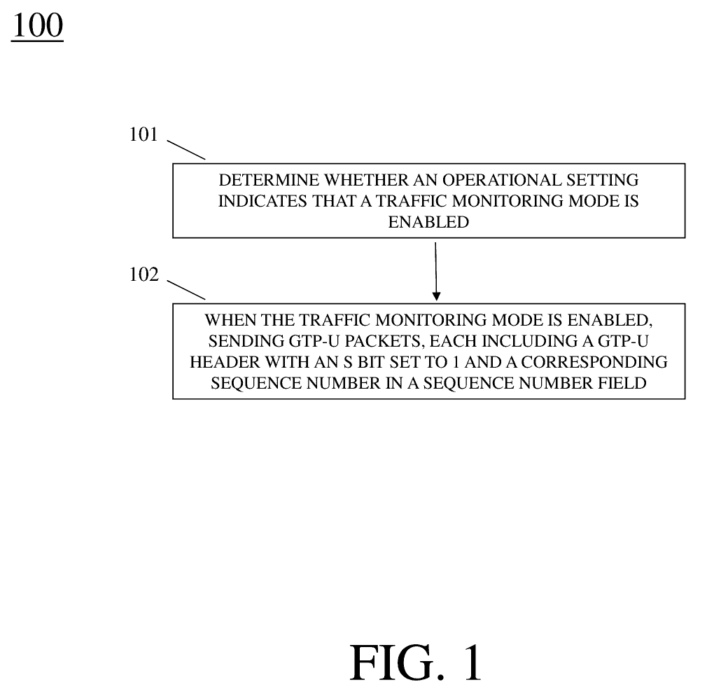

Specific embodiments of the present invention are disclosed below with reference to FIGS. 1-4. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the logic flow diagrams above are described and shown with reference to specific steps performed in a specific order, some of these steps may be omitted or some of these steps may be combined, sub-divided, or reordered without departing from the scope of the claims. Thus, unless specifically indicated, the order and grouping of steps is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### SUMMARY

Various methods and devices are provided to address the need for improved backhaul monitoring capabilities. In a first method, a network node determines whether an operational setting indicates that a traffic monitoring mode is enabled. When the traffic monitoring mode is enabled, the network node sends GPRS Tunneling Protocol-User (GTP-U) packets, each GTP-U packet including a GTP-U header with an S bit set to 1 and a corresponding sequence number in a sequence number field. An article of manufacture is also provided, the article comprising a non-transitory, processor-readable storage medium storing one or more software programs which when executed by one or more processors performs the steps of this first method.

Many embodiments are provided in which this first method is modified. For example, in many embodiments the traffic monitoring mode is disabled if the network node determines that an overload condition is present. In some embodiments, each

GTP-U packet further includes at least one extension header, the at least one extension header including at least one of an Evolved Packet System (EPS) bearer ID corresponding to that GTP-U packet, a QoS class identifier (QCI) corresponding to that GTP-U packet or a QCI group corresponding to that GTP-U packet. In some embodiments, each GTP-U packet further includes at least one extension header, the at least one extension header including a timestamp corresponding to that GTP-U packet. Depending on the embodiment, the network node may comprises a wireless network device from the group consisting of a serving gateway, a packet data network (PDN) gateway, and a base station.

In a second method, a network node receives GPRS Tunneling Protocol-User (GTP-U) packets, each GTP-U packet comprising a GTP-U header with an S bit set to 1 and a corresponding sequence number in a sequence number field. The network node then utilizes the corresponding sequence numbers of the received GTP-U packets to provide performance measurement (PM) counts of missed GTP-U packets. An article of manufacture is also provided, the article comprising a non-transitory, processor-readable storage medium storing one or more software programs which when executed by one or more processors performs the steps of this second method.

Many embodiments are provided in which this second method is modified. For example, in many embodiments, each of the received GTP-U packets includes at least one extension header, the at least one extension header including at least one of an Evolved Packet System (EPS) bearer ID corresponding to that GTP-U packet, a QoS class identifier (QCI) corresponding to that GTP-U packet or a QCI group corresponding to that GTP-U packet. In some embodiments, each of the received GTP-U packets comprises at least one extension header, the at least one extension header including a timestamp corresponding to that GTP-U packet. Depending on the embodiment, the network node may additionally perform one or more of the following: utilize corresponding Evolved Packet System (EPS) bearer IDs of the received GTP-U packets to provide PM counts on a per EPS bearer basis, utilize corresponding QoS class identifiers (QCIs) of the received GTP-U packets to provide PM counts on a per QCI basis, utilize corresponding QoS class identifier (QCI) groups of the received GTP-U packets to provide PM counts on a per QCI group basis, utilize corresponding timestamps of the received GTP-U packets to provide path jitter information, or utilize corresponding timestamps of the received GTP-U packets to provide path delay information. Depending on the embodiment, the network node may comprise a wireless network device from the group consisting of a serving gateway, a packet data network (PDN) gateway, and a base station. A first network node apparatus is also provided. The first network node includes a network interface for communication with other network devices and a processing unit, communicatively coupled to the network interface. The processing unit is configured to determine whether an operational setting indicates that a traffic monitoring mode is enabled and, when the traffic monitoring mode is enabled, to send GPRS Tunneling Protocol-User (GTP-U) packets via the network interface, wherein each GTP-U packet comprises a GTP-U header with an S bit set to 1 and a corresponding sequence number in a sequence number field. Many embodiments are provided in which this first network node apparatus is modified. Examples of such embodiments can be found described above with respect to the first method.

A second network node apparatus is also provided and includes a network interface for communication with other network devices and a processing unit, communicatively coupled to the network interface. The processing unit is configured to receive via the network interface GPRS Tunneling Protocol-User (GTP-U) packets, each GTP-U packet comprising a GTP-U header with an S bit set to 1 and a corresponding sequence number in a sequence number field. The processing unit is further configured to utilize the corresponding sequence numbers of the received GTP-U packets to provide performance measurement (PM) counts of missed GTP-U packets. Many embodiments are provided in which this second network node apparatus is modified. Examples of such embodiments can be found described above with respect to the second method.

### DETAILED DESCRIPTION OF EMBODIMENTS

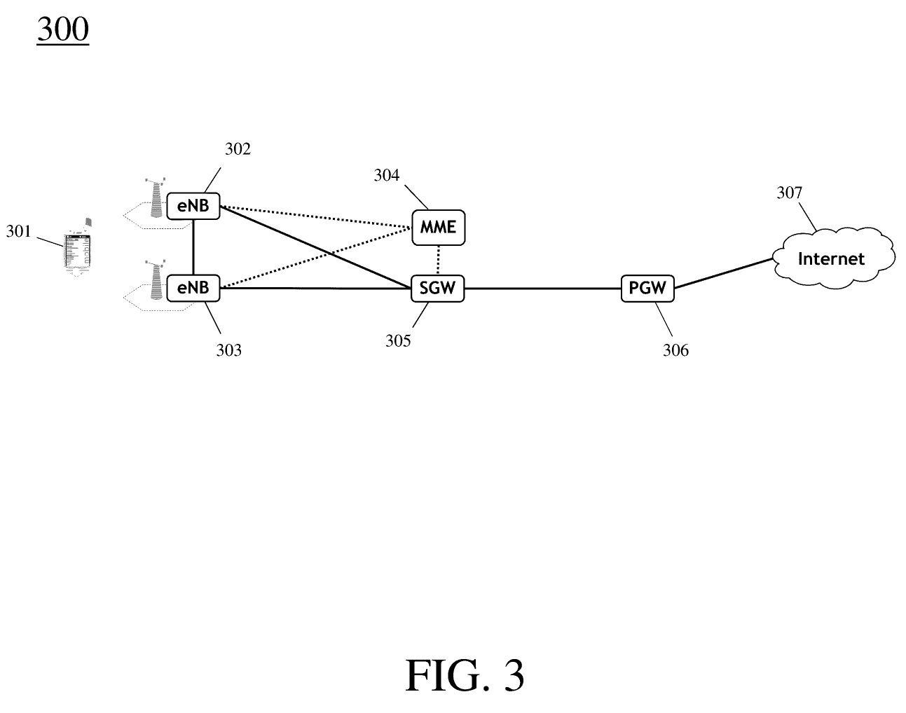

To provide a greater degree of detail in making and using various aspects of the present invention, a description of our approach to improved backhaul monitoring and a description of certain, quite specific, embodiments follow for the sake of example. FIG. 3 is referenced in an attempt to illustrate an example of a specific system in which the present invention may be embodied.

FIG. 3 is a block diagram depiction of a 3rd Generation Partnership Project (3GPP) Long Term Evolution (LTE) wireless network in accordance with certain embodiments of the present invention. The system depicted in diagram 300 includes an LTE wireless network providing service to mobile device (or UE) 301 via various network nodes such as eNBs 302 and 303, Serving Gateway (SGW) 305, and PDN Gateway (PGW) 306 connected to internet 307. Also depicted is Mobility Management Entity (MME) 304.

In LTE systems, the S1-U, the X2 and the S5 interfaces are based on GPRS Tunneling Protocol-User (GTP-U) as specified in TS 29.281. The GTP-U protocol supports the use of sequence numbers, which is optional (i.e., not required for GTP-U interfaces). The use of sequence numbers requires the S bit be set to 1 in the GTP-U header. The GTP-U protocol also supports extension headers including private extension headers. By setting the E bit in the header, the receiver knows an extension header is included.

A configurable parameter in any of the LTE nodes (e.g., in a PGW, a SGW or an eNB) can be used to determine when to turn on or off this backhaul monitoring capability. If monitoring is off, the S bit is set to 0, indicating that the sequence number field is not used and monitoring is not performed. If monitoring is on, then the LTE node will set the S bit to 1 and update the sequence number field (i.e., increment it every time a packet is sent). Based on the packets received and their sequence numbers, the receiving node is able to provide performance measurement (PM) counts for packets received and missed packets during a specified collection interval. Counts can be provided per bearer type (if EPS bearer IDs are specified).

The sender's timestamp can be included in a private extension header. Using this, the receiver can determine the path jitter and provide PM counters. The counters can also be per EPS bearer, so the QoS delay/jitter differentiation and performance can also be monitored and reported. If both sender and receiver have their local clocks synchronised to a certain accuracy (normally a 1 ms level is sufficient), the timestamp extension header can also determine the delay along the path, so such PM counters can also be provided. There are many ways to do such clock synchronisation, such as using GPS or NTP or IEEE1588 protocols.

Thus, various embodiments described herein seek to provide at least some of the following capabilities:

The capability to turn on/off GTP-U packet loss monitoring using the S-bit specified in the GTP-U header. The LTE node (e.g., eNB or S/PGW) can be configured with a parameter which allows for monitoring of the GTP-U packets. If monitoring is off, the S bit is set to 0 indicating that the sequence number field is not used and no monitoring is performed. Other conditions, such as the node being in an overload situation, may also cause packet monitoring to be turned off. If monitoring is on, then the LTE node will set the S bit to 1 and update the sequence number field (increment it for each packet sent). When monitoring is on, each node will provide PM counts for “packets received and missed packets” during the specified collection interval, based on packets received and sequence numbers.

The capability to monitor GTP-U packets per bearer type using the E-bit in the GTP-U header. The LTE node includes (in a private GTP-U extension header) the EPS bearer ID associated with the GTP-U packets, as well as the QCI. The LTE node provides a PM counter, per bearer type or QCI/QCI group (e.g., GBR and non-GBR), based on the EPS bearer ID, packets received and sequence number. Each bearer connection established for a UE is associated with a QCI (QoS Class Identifier). The QCI specifies traffic characteristics such as bearer type, priority, packet delay budget and packet error loss. Each bearer can be of type GBR (Guaranteed Bit Rate) typically for real time services or non-GBR (which are for best effort/non-real time services). Typically, bearers with QCI 1-4 are considered GBR bearers and bearers with QCI 5-9 are considered non-GBR bearers.

The capability to monitor jitter and delay for GTP-U packets by using the E-bit in the GTP-U header. The sending LTE node includes a timestamp in a private GTP-U header extension. The receiving LTE node provides a PM counter which will specify average jitter detected for all packets. If an EPS bearer ID is included, the jitter PM counts can be provided per bearer type (e.g., QCI, QCI groups). By using a clock synchronization technique, the path delay can also be monitored and the PM counters can be provided. Combining with the private extension of EPS bearer ID and QCI, the transport network performance can be monitored on a per EPS bearer basis. This will provide the performance statistics for QoS treatment and guarantees on the backhaul networks.

The solutions proposed above provide various capabilities for monitoring GTP-U packets on at least the S1-U, X2 and S5 open interfaces, based on standard GPT-U headers. Such capabilities may be quite valuable in verifying the SLA requirements of the transport network.

The detailed and, at times, very specific description above is provided to effectively enable a person of skill in the art to make, use, and best practice the present invention in view of what is already known in the art. In the examples, specifics are provided for the purpose of illustrating possible embodiments of the present invention and should not be interpreted as restricting or limiting the scope of the broader inventive concepts. In the examples, specific architectures, specific message names, specific message field values, specific messaging formats, and specific messaging sequences are all provided for the purpose of illustrating possible embodiments of the present invention and should not be interpreted as restricting or limiting the scope of the broader inventive concepts.

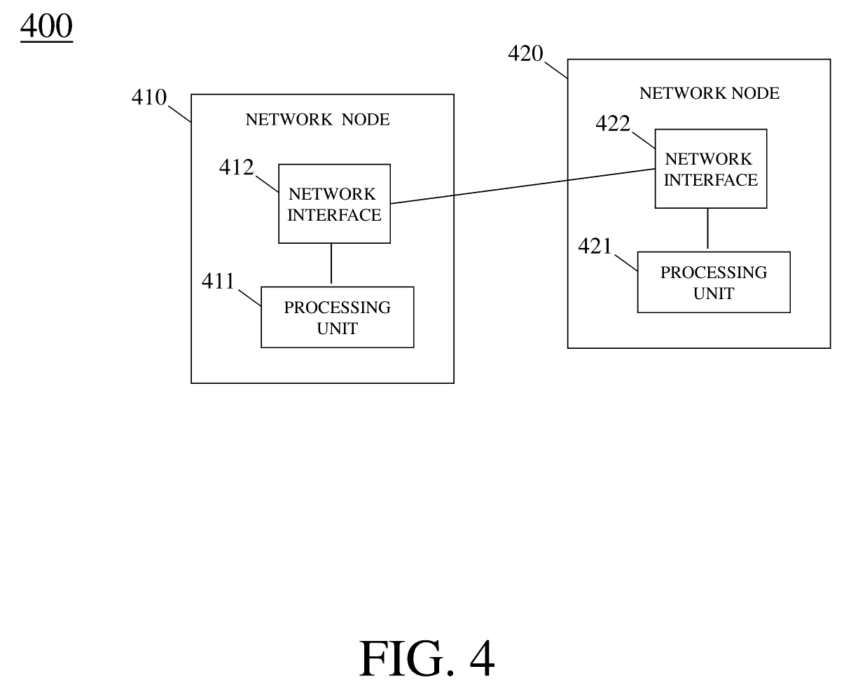

Having described certain embodiments in detail above, a review of the more general aspects common to many of the embodiments of the present invention can be understood with reference to FIGS. 1, 2 and 4. Diagram 400 of FIG. 4 depicts network nodes 410 and 420 in accordance with various embodiments of the present invention. Network nodes 410 and 420 include processing units 411 and 421, respectively, and network interfaces 412 and 422, respectively.

Those skilled in the art will recognize that the network depiction in FIG. 4 does not show all of the components necessary to operate in a commercial communications system but only those components and logical entities particularly relevant to the description of embodiments herein. For example, network nodes are known to comprise processing units and network interfaces. In general, such components are well-known. For example, processing units are known to comprise basic components such as, but neither limited to nor necessarily requiring, components from a group that includes microprocessors, microcontrollers, memory devices, application-specific integrated circuits (ASICs), and logic circuitry. Such components are typically adapted to implement algorithms or protocols that have been expressed using high-level design languages or descriptions, expressed using computer instructions, expressed using signaling flow diagrams, or expressed using logic flow diagrams.

Thus, given a high-level description, an algorithm, a logic flow, a messaging/signaling flow, or a protocol specification, those skilled in the art are aware of the many design and development techniques available to implement a processing unit that performs the given logic. Therefore, network nodes 410 and 420, for example, represent known devices that have been adapted, in accordance with the description herein, to implement multiple embodiments of the present invention. Furthermore, those skilled in the art will recognize that aspects of the present invention may be implemented in or across various physical components and none are necessarily limited to single platform implementations.

In the example of FIG. 4, network node processing unit 411 determines whether an operational setting (such as an operator-controlled configuration parameter) indicates that a traffic monitoring mode is enabled. When the traffic monitoring mode is enabled, processing unit 411 sends, via network interface 412, GTP-U packets in which the GTP-U header of each packet has the S bit is set to 1 and the sequence number field populated with the corresponding sequence number for that packet. Network node processing unit 421 receives via network interface 422 most (if not all) of the GTP-U packets sent from network node 410. Processing unit 421 utilizes the corresponding sequence numbers of the received GTP-U packets to provide performance measurement (PM) counts of missed GTP-U packets.

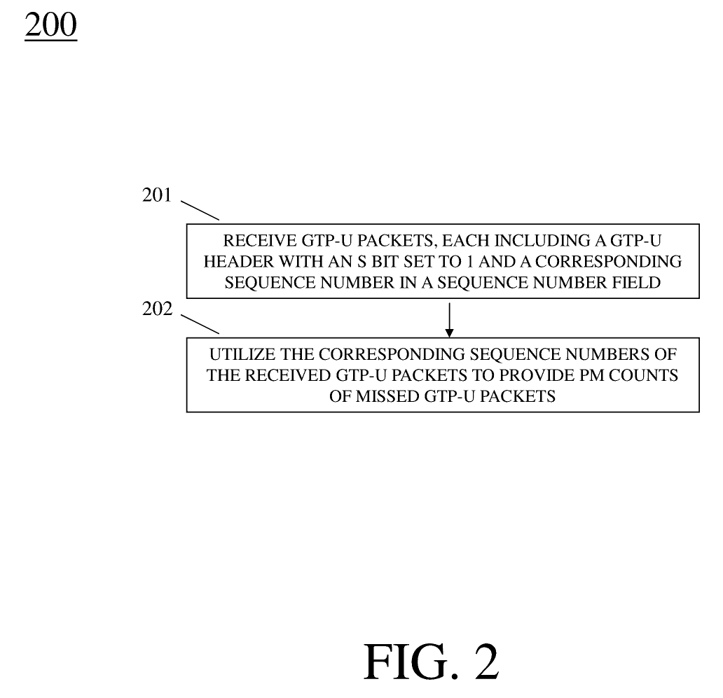

Aspects of embodiments of the present invention can be understood with reference to FIGS. 1 and 2. Diagram 100 of FIG. 1 is a logic flow diagram of functionality performed by a sending network node in accordance with various embodiments of the present invention. Diagram 200 of FIG. 2 is a logic flow diagram of functionality performed by a receiving network node in accordance with various embodiments of the present invention. In the example of FIG. 4, network node 410 was a sending network node, while network node 420 was a receiving network node.

In the method depicted in diagram 100, a network node determines (101) whether an operational setting indicates that a traffic monitoring mode is enabled. When the traffic monitoring mode is enabled, the network node sends (102) GTP-U packets, each GTP-U packet including a GTP-U header with an S bit set to 1 and a corresponding sequence number in a sequence number field.

Many embodiments are provided in which the method depicted in diagram 100 is modified. For example, in many embodiments the traffic monitoring mode is disabled if the network node determines that an overload condition is present. In some embodiments, each GTP-U packet further includes at least one extension header, the at least one extension header including at least one of an Evolved Packet System (EPS) bearer ID corresponding to that GTP-U packet, a QoS class identifier (QCI) corresponding to that GTP-U packet or a QCI group corresponding to that GTP-U packet. In some embodiments, each GTP-U packet further includes at least one extension header, the at least one extension header including a timestamp corresponding to that GTP-U packet. Depending on the embodiment, the network node may comprises a wireless network device from the group consisting of a serving gateway, a packet data network (PDN) gateway, and a base station.

In the method depicted in diagram 200, a network node receives (201) GTP-U packets, each GTP-U packet comprising a GTP-U header with an S bit set to 1 and a corresponding sequence number in a sequence number field. The network node then utilizes (202) the corresponding sequence numbers of the received GTP-U packets to provide PM counts of missed GTP-U packets.

Many embodiments are provided in which the method depicted in diagram 200 is modified. For example, in many embodiments, each of the received GTP-U packets includes at least one extension header, the at least one extension header including at least one of an Evolved Packet System (EPS) bearer ID corresponding to that GTP-U packet, a QoS class identifier (QCI) corresponding to that GTP-U packet or a QCI group corresponding to that GTP-U packet. In some embodiments, each of the received GTP-U packets comprises at least one extension header, the at least one extension header including a timestamp corresponding to that GTP-U packet. Depending on the embodiment, the network node may additionally perform one or more of the following: utilize corresponding Evolved Packet System (EPS) bearer IDs of the received GTP-U packets to provide PM counts on a per EPS bearer basis, utilize corresponding QoS class identifiers (QCIs) of the received GTP-U packets to provide PM counts on a per QCI basis, utilize corresponding QoS class identifier (QCI) groups of the received GTP-U packets to provide PM counts on a per QCI group basis, utilize corresponding timestamps of the received GTP-U packets to provide path jitter information, or utilize corresponding timestamps of the received GTP-U packets to provide path delay information. Depending on the embodiment, the network node may comprise a wireless network device from the group consisting of a serving gateway, a packet data network (PDN) gateway, and a base station.

A person of skill in the art would readily recognize that steps of various above-described methods can be performed by programmed computers. Herein, some embodiments are intended to cover program storage devices, e.g., digital data storage media, which are machine or computer readable and encode machine-executable or computer-executable programs of instructions where said instructions perform some or all of the steps of methods described herein. The program storage devices may be, e.g., digital memories, magnetic storage media such as a magnetic disks or tapes, hard drives, or optically readable digital data storage media. The embodiments are also intended to cover computers programmed to perform said steps of methods described herein.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms “a” or “an”, as used herein, are defined as one or more than one. The term “or”, as used herein, is defined as an inclusive or, which is satisfied by one or more than one of objects being present or true. The term plurality, as used herein, is defined as two or more than two. The term another, as used herein, is defined as at least a second or more. Unless otherwise indicated herein, the use of relational terms, if any, such as first and second, top and bottom, and the like are used solely to distinguish one entity or action from another entity or action without necessarily requiring or implying any actual such relationship or order between such entities or actions.

The terms “including” or “having”, as used herein, are defined as comprising (i.e., open language). The term “coupled”, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

What is claimed is:

1. A method for traffic monitoring, the method comprising:
determining by a network node whether an operational setting indicates that a traffic monitoring mode is enabled;
when the traffic monitoring mode is enabled, sending by the network node GPRS Tunneling Protocol-User (GTP-U) packets, wherein each GTP-U packet comprises a GTP-U header with an S bit set to 1 and a corresponding sequence number in a sequence number field.

2. The method as recited in claim 1, further comprising:
disabling the traffic monitoring mode, if the network node determines that an overload condition is present.

3. The method as recited in claim 1, wherein each GTP-U packet further comprises at least one extension header, the at least one extension header including at least one of an Evolved Packet System (EPS) bearer ID corresponding to that GTP-U packet, a QoS class identifier (QCI) corresponding to that GTP-U packet or a QCI group corresponding to that GTP-U packet.

4. The method as recited in claim 1, wherein each GTP-U packet further comprises at least one extension header, the at least one extension header including a timestamp corresponding to that GTP-U packet.

5. The method as recited in claim 1, wherein the network node comprises a wireless network device from the group consisting of a serving gateway, a packet data network (PDN) gateway, and a base station.

6. A method for traffic monitoring, the method comprising:
receiving by a network node GPRS Tunneling Protocol-User (GTP-U) packets, each GTP-U packet comprising a GTP-U header with an S bit set to 1 and a corresponding sequence number in a sequence number field;
utilizing the corresponding sequence numbers of the received GTP-U packets to provide performance measurement (PM) counts of missed GTP-U packets.

7. The method as recited in claim 6, wherein each of the received GTP-U packets comprises at least one extension header, the at least one extension header including at least one of an Evolved Packet System (EPS) bearer ID corresponding to that GTP-U packet, a QoS class identifier (QCI) corresponding to that GTP-U packet or a QCI group corresponding to that GTP-U packet.

8. The method as recited in claim 6, further comprising utilizing corresponding Evolved Packet System (EPS) bearer IDs of the received GTP-U packets to provide PM counts on a per EPS bearer basis.

9. The method as recited in claim 6, further comprising
utilizing corresponding QoS class identifiers (QCIs) of the received GTP-U packets to provide PM counts on a per QCI basis.

10. The method as recited in claim 6, further comprising utilizing corresponding QoS class identifier (QCI) groups of the received GTP-U packets to provide PM counts on a per QCI group basis.

11. The method as recited in claim 6, wherein each of the received GTP-U packets comprises at least one extension header, the at least one extension header including a timestamp corresponding to that GTP-U packet.

12. The method as recited in claim 6, further comprising utilizing corresponding timestamps of the received GTP-U packets to provide path jitter information.

13. The method as recited in claim 6, further comprising
utilizing corresponding timestamps of the received GTP-U packets to provide path delay information.

14. The method as recited in claim 6, wherein the network node comprises a wireless network device from the group consisting of a serving gateway, a packet data network (PDN) gateway, and a base station.

15. A network node comprising:
a network interface for communication with other network devices; and
a processing unit, communicatively coupled to the network interface, configured
to determine whether an operational setting indicates that a traffic monitoring mode is enabled, and
to send, when the traffic monitoring mode is enabled, GPRS Tunneling Protocol-User (GTP-U) packets via the network interface, wherein each GTP-U packet comprises a GTP-U header with an S bit set to 1 and a corresponding sequence number in a sequence number field.

16. A network node comprising:
a network interface for communication with other network devices; and
a processing unit, communicatively coupled to the network interface, configured
to receive, via the network interface, GPRS Tunneling Protocol-User (GTP-U) packets, each GTP-U packet comprising a GTP-U header with an S bit set to 1 and a corresponding sequence number in a sequence number field, and
to utilize the corresponding sequence numbers of the received GTP-U packets to provide performance measurement (PM) counts of missed GTP-U packets.

17. The network node as recited in claim 16, wherein the processing unit is further configured
to utilize corresponding Evolved Packet System (EPS) bearer IDs of the received GTP-U packets to provide PM counts on a per EPS bearer basis.

18. The network node as recited in claim 16, wherein the processing unit is further configured
to utilize corresponding QoS class identifiers (QCIs) of the received GTP-U packets to provide PM counts on a per QCI basis.

19. The network node as recited in claim 16, wherein the processing unit is further configured
to utilize corresponding QoS class identifier (QCI) groups of the received GTP-U packets to provide PM counts on a per QCI group basis.

20. The network node as recited in claim 16, wherein the processing unit is further configured
to utilize corresponding timestamps of the received GTP-U packets to provide path jitter information and to provide path delay information.
